(19) United States
(12) Patent Application Publication
(10) Pub. No.: US 2008/0117317 A1
(43) Pub. Date: May 22, 2008

(54) Dim row suppression system and method for active pixel sensor arrays

(76) Inventor: Ray Alan Mentzer, Loveland, CO (US)

Correspondence Address: RatnerPrestia, P.O. BOX 980, VALLEY FORGE, PA, 19482, US

(21) Appl. No.: 11/601,346

(22) Filed: Nov. 17, 2006

(51) Int. Cl. H04N 9/64

(52) U.S. Cl. 348/245

(57) ABSTRACT

An active pixel sensor array includes an imaging sensor subarray, a first reference subarray positioned on a first side of the imaging sensor subarray. The first reference subarray includes a first reference column line. A second reference subarray is positioned on a second side of the imaging subarray. The second reference subarray includes a second reference column line that is electrically coupled to the first reference column line to generate a common reference signal from the first and second reference subarrays. The active pixel sensor array may be a CMOS image sensor and each reference subarray may include a plurality of column lines associated with a plurality of columns of pixels.

### BACKGROUND OF THE INVENTION

Active pixel sensor arrays contain an array of individual photo sensors or pixels that are typically arranged in rows and columns to capture digital image data. These sensor arrays, which are commonly referred to as complementary metal oxide semiconductor (CMOS) image sensors since they are commonly fabricated using CMOS processing technology, are used in a wide variety of commonplace consumer electronic devices, such as digital still cameras, digital video cameras, and image copying devices. Each pixel in such an array includes a photo-detector that is typically a photo diode and which functions to sense the intensity of light incident upon the photo detector during an exposure period and to provide an electrical signal indicating the intensity of the sensed light. The values of the these electrical signals are then read from the pixels in the array one row at a time, with the values of all pixels in the array being designated a “frame” of digital data representing a captured image. The overall operation of conventional sensor arrays is well understood by those skilled in the art and will not be described in detail herein. U.S. Pat. No. 5,471,515 to Fossum et al., for example, provides such a description and is incorporated herein by reference.

In prior sensor arrays, the values of electrical signals provided by each pixel were initially determined with reference to ground. The electrical signals output from the pixels and the ground signal can, however, be subjected to different noise levels and other unequal affects that result in noise or erroneous values being read for the signals from the pixels. Such erroneous values result in a less accurate indication of incident light upon each pixel and therefore to a lower quality captured digital image data. Noise on the electrical signals read from pixels as well as on the ground signal can result from a variety of factors during operation of the array, such as switching noise that results when a row of pixels is activated, as will be understood by those skilled in the art.

A prior approach to reduce the noise that may be present on the electrical signals read from pixels is to include reference pixels on one or both sides of the active pixel sensor array. An active pixel sensor array utilizing reference pixels on one side of the array, or on both sides of the array to advantageously increase the frame rate of the sensor array, is disclosed in U.S. Pat. No. 6,476,864 to Borg et al (“Borg”), which is incorporated herein by reference. With such an approach, the sensor array includes an imaging subarray containing pixels that sense incident light from an object to capture the desired image. On one or both sides of the imaging subarray are reference subarrays including reference pixels that are covered so that they are not subjected to incident light but that otherwise have an identical structure as the pixels in the imaging subarray.

When reading data out of the active pixel sensor array, a given row of pixels is activated at a time, which activates both the pixels contained in the imaging subarray and the pixels contained in the reference subarray for that row. These pixels will be referred to as imaging pixels and reference pixels, respectively, in the following description. A differential circuit then generates for each activated imaging pixel an output based upon the difference between the voltage on a reference column line coupled to the activated reference pixel or pixels in the row and the voltage on a column line coupled to an activated imaging pixel. Ideally, the reference pixels experience the same noise as the imaging pixels so that taking the difference between these two signals eliminates or greatly reduces any noise on the electrical signal or voltage being read from each activated imaging pixel. For example, switching noise resulting from the activation of the imaging and reference pixels will be present on both the column line and the reference column line, meaning that this differential read out method eliminates such noise from the generated output.

Note that for proper operation an active pixel sensor array utilizing this differential readout method, the proper voltage must be present on the reference column lines. If this is not true, then the generated differential output will have a value that does not accurately indicate the intensity of incident light upon each imaging pixel in the activated row. As will be understood by those skilled in the art, a maximum voltage is typically the desired voltage present on each reference column line. This is true since during the operation of an active pixel sensor array, the pixels, both imaging and reference, are reset prior to the imaging pixels being exposed to incident light to capture an image. During this reset process, the photo detectors in each pixel are typically charged to a maximum voltage, with subsequent exposure to incident light then discharging the photo detectors and thereby reducing the voltage in the imaging pixels.

Since the reference pixels are covered, typically with metal layers and color filters that also cover the imaging pixels, there are two primary ways in which the voltages on the reference column lines can vary. The reference column lines are coupled to the photo detectors in the reference pixels during reading operations, as will be appreciated by those skilled in the art. The first source of error in the reference pixels results from what are termed “hot pixels.” A hot pixel is a pixel having a high leakage current that causes the photo detector to discharge even when there is no light incident on the photo detector. Such hot pixels present a problem when the hot pixel is a reference pixel. This is true because the hot pixel will result in an erroneous voltage on the reference column line and this erroneous voltage will then be subtracted from each voltage being read out of the imaging pixels in the associated row.

During operation, the imaging pixels have voltages that are less than the maximum value due to their exposure in incident light. Now if the voltage on the reference column lines is less due to a hot pixel, the resulting differential output signal will have a smaller than desired value. This erroneous difference will occur for all imaging pixels in the given row, which results in the sensed values for the entire row being less than desired. The sensed values being less than desired values corresponds to the pixels in that row of the captured image being dim, with such a row commonly being referred to as a “dim row.”

Another phenomenon known as “optical leakage” can lead to erroneous image data being read out of an active pixel sensor array that utilizes the differential read out approach being discussed. Optical leakage is unwanted light incident upon the reference pixels. Recall, ideally the reference pixels are covered so that no light is incident upon these pixels. In practice, however, the manner in which the reference pixels are covered results in the possibility that some light associated with an image being captured may be incident upon the reference pixels. As previously mentioned, the reference pixels are typically covered with some sort of metal layer and color filter structure. Without discussing the details of such a structure, the arrangement of layers of metal and stacks of color filters forming the structure can result in openings being present. Incident light may then propagate through these openings and reflect off the structure to illuminate the underlying reference pixels. Such unwanted illumination of the reference pixels results in an unwanted discharge of the photo detectors in the reference pixels, causing errors in the differential output signal as previously described above for hot pixels.

It should also be noted that where reference pixels are located on both sides of the imaging subarray, the reference pixels on one side of the subarray may experience different optical leakage than the reference pixels on the other side of the subarray. For each row, reference pixels on one side of the imaging subarray are used when reading out even columns of imaging pixels in the row, for example. In this situation, the reference pixels on the other side of the subarray are used when reading out odd columns of the imaging subarray. Different amounts of optical leakage for reference pixels on one side of the imaging subarray versus the other side will result in different errors for the odd and even pixels being read out of respective row, introducing a further unwanted source of error.

There is a need for an improved system and method for reading sensed image data out of active pixels sensor arrays such as CMOS image sensors.

### SUMMARY OF THE INVENTION

According to one aspect of the present invention, an active pixel sensor array includes an imaging sensor subarray, a first reference subarray positioned on a first side of the imaging sensor subarray, and a second reference subarray positioned on a second side of the imaging subarray. The first imaging subarray includes a first column line that is electrically coupled to a second column line of the second subarray to generate a common reference signal from the first and second reference subarrays.

### BRIEF DESCRIPTION OF THE DRAWINGS

FIG. 1 is a block diagram illustrating an active pixel sensor array including two interconnected reference subarrays positioned on the sides of an imaging subarray according to one embodiment of the present invention.

FIG. 2 is a functional block diagram illustrating in more detail the active pixel sensor array of FIG. 1 according to one embodiment of the present invention.

FIG. 3 is a diagram illustrating in more detail an example of one of the photo sensors or pixels contained in the imaging and reference subarrays of FIG. 2.

FIG. 4 is a schematic diagram illustrating in more detail the interconnection of the photo sensors or pixels within the reference subarrays of FIG. 1 or 2 according to one embodiment of the present invention.

FIG. 5 is a functional block diagram illustrating an electronic system including the active pixel sensor array of FIG. 1 or 2 according to an embodiment of the present invention.

### DETAILED DESCRIPTION OF PREFERRED EMBODIMENTS

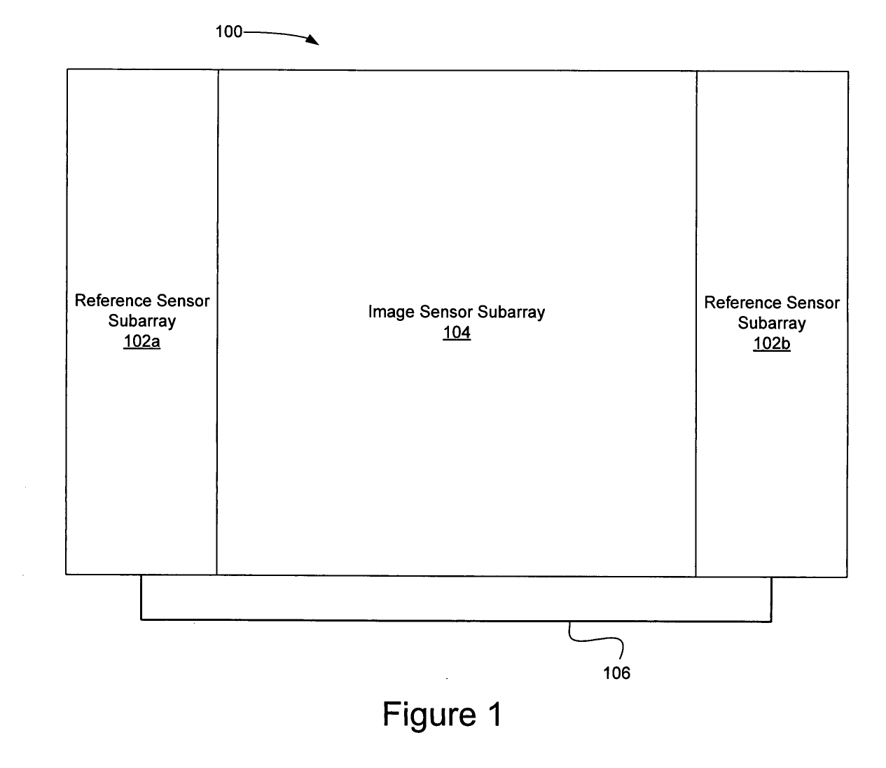

FIG. 1 is a block diagram illustrating an active pixel sensor array 100 including two electrically interconnected reference subarrays 102a and 102b positioned on the sides of an imaging subarray 104 according to one embodiment of the present invention. Each of the reference subarrays 102a and 102b includes a plurality of photo sensors or pixels (not shown), with the pixels in the left reference subarray 102a being electrically coupled to the pixels in the right reference subarray 102b. This electrical interconnection of the two reference column lines is illustrated in FIG. 1 through a conductive line 106 interconnecting the two reference subarrays. Inclusion of interconnected reference subarrays 102a and 102b on both sides of the imaging subarray 104 reduces the affects of optical leakage that may affect pixels (not shown) in one of the subarrays 102a or 102b and thereby reduces the affects of or suppresses dim rows that may otherwise arise from such leakage, as will be explained in more detail below. This approach also reduces the affects of or suppresses dim rows that may otherwise result from “hot pixels” in the reference subarrays 102, as will also be discussed in more detail below.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, combinations, and subcombinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail below to avoid unnecessarily obscuring the present invention.

Also note that in the following description when utilizing reference descriptors such as 102a and 102b that include letters and numbers, or reference descriptors including subscripts, the letter or subscript may be omitted when referring to any or all of the components associated with the reference descriptors. Only when referring to a specific one or ones of the components will both the letters and numbers typically be utilized.

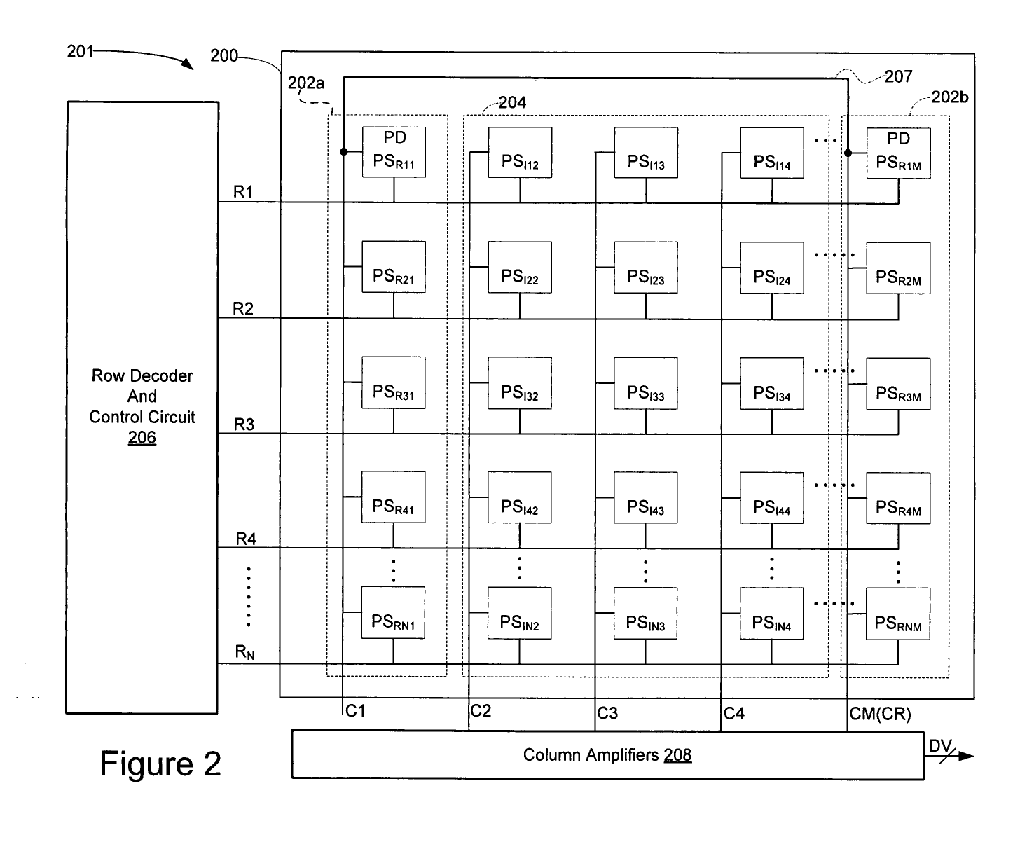

The structure and operation of the active pixel sensor array 100 of FIG. 1 will now be described in more detail with reference to FIG. 2, which is a functional block diagram of an active pixel sensor array 200 contained in an imaging device 201 according to one embodiment of the present invention. The active pixel sensor array 200 is one embodiment of the active pixel sensor array 100 and shows more details of the functional structure of the array. The sensor array 200 includes left and right reference subarrays 202a, 202b and an imaging subarray 204. Each of the subarrays 202 and 204 includes a plurality of pixels or photo sensors PS arranged in rows and columns.

Each of the photo sensors PS includes a subscript indicating more specifically the location of the photo sensor in the sensor array 200. Each subscript first includes either an “R” or an “I” to indicate whether the photo sensor is in one of the reference subarrays 202 or the imaging subarray 204, respectively. Two numbers follow the R or I, with the first number indicating a row and the second number a column position of the photo sensor PS in the sensor array 200. The sensor array assumed to include N rows and M columns. For example, in one embodiment the sensor array 200 is an N×M array of photo sensors PS where N=2056 and M=1544 and where each reference subarray 202a and 202b includes 8 columns of photo sensors. Although each reference subarray 202a and 202b is shown as including only a single column of photo sensors PS, each of these subarrays typically includes more than one column of sensors according to other embodiments of the sensor array 200.

The sensor array 200 further includes a plurality of row lines R1-RN, each row line being coupled to a corresponding row of photo sensors PS in the array. A row decoder and control circuit 206 applies row control signals over the row lines R1-RN to control and activate respective rows of the photo sensors PS in the array 200. The row control signals that the row decoder and control circuit 206 applies on each row line R1-RN function to reset and thereafter access the corresponding row of photo sensors PS, as will be described in more detail below.

Similar to the row lines R, the sensor array 200 further includes a plurality of column lines C1-CM, each column line being coupled to a corresponding column of photo sensors PS. The column lines C1 and CM are coupled to the photo sensors in the reference subarrays 202a and 202b and are also coupled together or interconnected through conductive lines 207. These interconnected column lines C1 and CM are alternatively designated as a reference column line CR. Column amplifiers 208 are coupled to the column lines C2-CM and sense voltages developed on the column lines by activated rows R of photo sensors PS. The column amplifiers 208 then output for each column line C2-CM-1 in the imaging subarray 204 a differential voltage DV corresponding to the difference between the sensed voltage on the column line and the voltages on the column lines C1 and CM of the reference subarrays 202a, 202b, as will be described in more detail below.

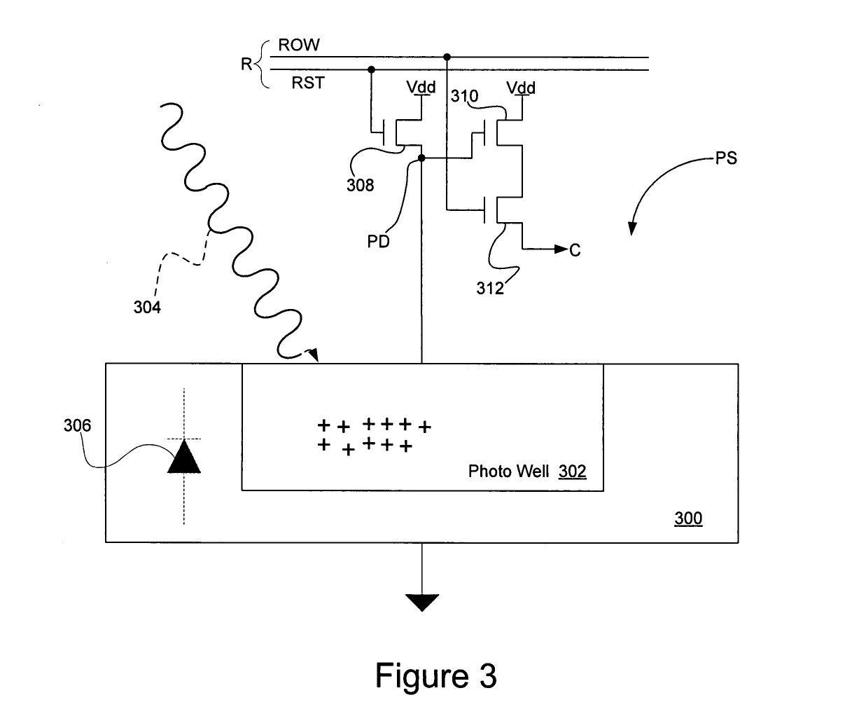

Before describing the overall operation of the imaging device 201, a typical structure of one of the photo sensors PS contained in the imaging and reference subarrays 202 and 204 (FIG. 2) will first be described with reference to FIG. 3. This understanding of this structure of the photo sensors will help one understand the overall operation of the device 201. The photo sensor PS is typically formed in a semiconductor substrate 300 and includes a photo detector or photo well 302 for sensing an intensity of light 304 incident upon the photo well. The photo well 302 is typically formed from a suitable semiconductor material having the opposite conductivity as the substrate 300 such that a photo diode 306 is formed by the junction of the photo well and substrate, as illustrated in the figure.

The photo sensor PS further includes a reset transistor 308 that coupled between the photo well 302 and a supply voltage source Vdd, with the interconnection of the source of the transistor and the photo well defining a photo detector node PD. In response to a reset signal RST, the transistor 308 turns ON to charge the photo well 302, as represented by the positive charges “+” contained in the photo well. An amplifying transistor 310 receives the voltage on the node PD and operates as a source follower to provide this voltage less a threshold voltage V_{T} on the source of the transistor. An access transistor 312 receives a row activation signal ROW and, when the row activation signal is active, turns ON to provide the voltage at the source of the amplifying transistor 310 to a column line C coupled to the source of the access transistor. Note that collectively the row activation signal ROW and reset signal RST correspond to the row control signals supplied by the row address and control circuit 206 (FIG. 2) on each of the row lines R. The photo sensor PS of FIG. 3 is commonly referred to as a “3T” photo sensor because it includes three transistors, namely the transistors 308, 310, and 312.

The overall operation of the imaging device 201 and photo sensors PS in the subarrays 202 and 204 will now be described in more detail with reference to FIGS. 2 and 3. In operation, before the imaging device 201 captures an image, the row decoder and control circuit 206 first activates the reset signals RST applied to all the photo sensors PS. In response to the active RST signal, the reset transistor 308 in each photo sensor PS turns ON and charges the photo well 302. At this point the photo well 302 is fully charged such that the node PD has a maximum value, namely the supply voltage Vdd less the threshold voltage V_{T} of the reset transistor 308.

The photo sensors PS in the imaging subarray 204 are then exposed to incident light from the object for which an image is to be captured. As a result of this exposure, incident light from the object discharges the photo wells 302 of the photo sensors PS in the imaging subarray 204, with the intensity of the incident light on each photo well determining how much that photo well is discharged and thus the value of the voltage on that photo well and on the corresponding node PD. After an exposure time the photo wells 302 of the photo sensors PS in the imaging subarray 204 have been discharged by varying amounts, with the remaining amount of charge determining the value of the voltage at the node PD.

Once the exposure time has elapsed, the voltage value at the node PD of each photo sensor PS in the imaging subarray 204 must be read from the imaging subarray 204. To read the voltage values from all the photo sensors PS in the imaging sensor subarray 204, the row decoder and control circuit 206 sequentially activates the ROW signal on the row lines R1-RN to read the values out one row at a time. After the row decoder and control circuit 206 activates the ROW signal for a given row of photo sensors PS to thereby activate these photo sensors, the column amplifiers 208 generate a differential voltage DV for each photo sensor in the active row. For each photo sensor PS in the activated row, the differential voltage DV corresponds to the difference between the voltage on the column line C2-CM-1 coupled to that photo sensor and the voltage on the reference column line CR. The column amplifiers 208 generate a differential voltage DV for each photo sensor PS in the activated row.

The row decoder and control circuit 206 and column amplifiers 208 operate in this manner to sequentially activate each row of photo sensors PS in the imaging subarray 204 and generate a differential voltage DV for each activated photo sensor. The column amplifiers 208 typically provide the generated differential voltages DV to other circuitry (not shown) in the imaging device 201. For example, this other circuitry typically digitizes each of these differential voltage DV values to thereby generate a digital value for the voltage value at the node PD for each photo sensor PS in the activated row. The collection of digital values for the differential voltages DV of all photo sensors PS in the imaging subarray 204 forms a digital image file of the captured image.

As previously described, the light incident upon photo wells 302 of the photo sensor PS in the imaging subarray 204 results in charge being removed from these photo wells and thereby reduces the voltages on the corresponding nodes PD. When very little light is incident upon the photo well 302 of a photo sensor PS, the voltage on the photo well 302 is accordingly relatively large. If no light is incident upon the photo well 302 of a photo sensor PS, the voltage on the photo well 302 will be a maximum equal to approximately Vdd-V_{T}, where V_{T} is the threshold voltage of the reset transistor 308. This maximum voltage on the photo well 302 will of course result in a corresponding maximum voltage V_{MAX} supplied on the column line C by such a photo sensor PS. Such a photo sensor PS or pixel will be referred to as a “black pixel.”

The photo sensors PS in the reference subarrays 202 ideally receive no incident light, as previously described. These photo sensors or pixels PS are thus ideally black pixels that present a maximum voltage V_{MAX} of Vdd minus 2V_{T} on the associated reference column line C, where V_{T} is the threshold voltage of the reset transistor 308 and source follower transistor 310. By interconnecting the column lines C1 and CM of the pixels PS in the reference subarrays 202 to form the single reference column line CR, the affects of any hot pixels or optical leakage is eliminated or reduced, as will now be described in more detail.

First, with regard to optical leakage, recall that as previously discussed different levels of incident light upon the pixels PS in the reference subarrays 202a and 202b can result in different amounts of optical leakage in each reference subarray. By coupling the column lines C of the two reference subarrays 202a and 202b together to form the single reference column line CR, the affects of any optical leakage is alleviated. This is true because any optical leakage that results in the voltage levels on the column lines C of one reference subarray 202 will be offset by the voltage levels on the column lines of the other reference subarray 202. For example, assume the pixels in the reference subarray 202a experience optical leakage such that the voltage on the column line C1 would equal V_{MAX}-V_{LEAK} if this column line were not coupled to the column line CM of the reference subarray 202b. Now assume the pixels in the reference subarray 202b experience no optical leakage such that the voltage on the column line CM would equal V_{MAX} if this column line were not coupled to the column line C1. As a result of the interconnection of the column lines C1 and CM, the column line CR is driven to the higher of the two voltages that would be present on the individual column lines C1 and CM, as will now be explained in more detail.

Referring back to FIG. 3, recall the amplifying transistor 310 in each pixel PS functions as a source follower, driving the voltage at the source of this transistor to the voltage on the photo detector node PD less the threshold voltage V_{T} of this transistor. As a result, assuming the reference pixels PS in only one of the reference subarrays 202a and 202b experience optical leakage, the voltage on the node PD of the pixels in the other subarray will be at approximately their ideal maximum values of V_{dd}-V_{T}. In response to this ideal maximum voltage V_{dd}-V_{T} applied to the sources of the amplifying transistors 310 of these pixels PS, these transistors function as source followers to drive the corresponding column lines C to approximately the maximum voltage V_{MAX}. The column lines C in the subarray 202 containing pixels PS that experience optical leakage will also be driven to the maximum voltage V_{MAX} by the amplifying transistors 310 in the subarray that does not experience optical leakage.

Assume, for example, that the subarray 202a experiences optical leakage while the subarray 202b does not. In this situation, the amplifying transistors 310 of the pixels PS in the subarray 202b drive the reference column line CR to the desired maximum voltage V_{MAX}. The reference column line CR is driven to the higher of the two voltages that the amplifying transistors 310 in each subarray 202 would independently drive the associated column line C1 and CM to if these column lines were not interconnected. It is unlikely that the both the subarrays 202a and 202b will simultaneously experience optical leakage. As a result, in this embodiment of the present invention the subarray 202 that does not experience optical leakage will compensate for the other subarray when that other subarray does experience optical leakage.

The interconnection of the column lines C1 and CM in the reference subarrays 202a and 202b similarly enables one of the arrays to compensate for “hot pixels” that may be present in the other one of the arrays. As just discussed, the reference column line CR is driven to the higher of the two voltages that the amplifying transistors 310 in each subarray 202 would independently drive the associated column line C1 and CM to if these column lines were not interconnected. This also applies in the situation where a hot pixel PS is present in one of the subarrays 202a and 202b. For example, if a given row of pixels PS in the subarray 202a includes a “hot pixel”, the amplifying transistor 310 of that pixel would drive the associated column line C1 to a voltage less than V_{MAX}. Because this column line C1 is connected to the column line CM of the subarray 202b, however, the reference column line CR will still be driven to the desired V_{MAX} by the amplifying transistor 310 of the pixel in the corresponding row in the subarray 202b. Once again, it is unlikely that the pixels PS in a given row in both the subarray 202a and 202b will be hot pixels. The reference column line CR will accordingly be driven to the desired voltage V_{MAX} by the amplifying transistor 310 that is not contained in the hot pixel.

The active pixel sensor array 200 decreases the occurrence of dim rows that can result from prior arrays utilizing reference pixels. This is true because through the interconnection of the column lines C1 and CM of the reference subarrays 202a and 202b through conductive lines 207 eliminates these types of errors so long as the errors don't occur simultaneously in both subarrays 202a and 202b. The pixels PS in one subarray 202 compensate for the pixels in the other subarray to eliminate errors that can result in dim rows.

One skilled in the art will appreciate that the above description of the operation of the active pixel sensor array 200, row decoder and control circuit 206, and column amplifiers 208 is a simplified overall functional description of these components. Details of such operation have not been presented in order to avoid confusing aspects of the present invention illustrated by the sample embodiments of the present invention described herein. For example, the above description indicates for each pixel PS in the activated row, the differential voltage DV from the column amplifiers 208 corresponds to the difference between the voltage on the column line C2-CM-1 coupled to that pixel and the voltage on the reference column line CR.

One skilled in the art will appreciate that in reading data out of the active pixel sensor array 200, two samples of the voltage present on the column line C for each imaging pixel PS and reference pixel will typically be used in generating the differential voltage DV. More specifically, for each imaging pixel PS in the imaging subarray 204 and each reference pixel in the subarrays 202a and 202b, the column amplifiers 208 sample the voltage on the corresponding column line C after the exposure time when this voltage may be termed an exposed signal level. After sampling this exposed signal level, the column amplifiers 208 sample the voltage on the column line C when the pixel PS is being reset (i.e., when the RST signal is active), which may be termed a reset signal level. For each imaging pixel PS, the difference between the two exposed signal levels may be termed a differential exposed signal level while the difference between the two reset signal levels may be termed a differential reset signal level. The differential voltage DV for each imaging pixel PS is then determined by the difference between the differential exposed signal level and the differential reset pixel level. This approach eliminates power supply noise as well as other sources of noise, such as noise associated with “dark current” of the pixels PS in the imaging subarray, that may otherwise be present on the values read out of the pixels PS of the imaging subarray 204, as will be appreciated by those skilled in the art. Dark current is current in a pixel PS even when the pixel is not being illuminated and usually results from thermal excitation of charge carriers. This approach is described in more detail in the previously mentioned Borg patent.

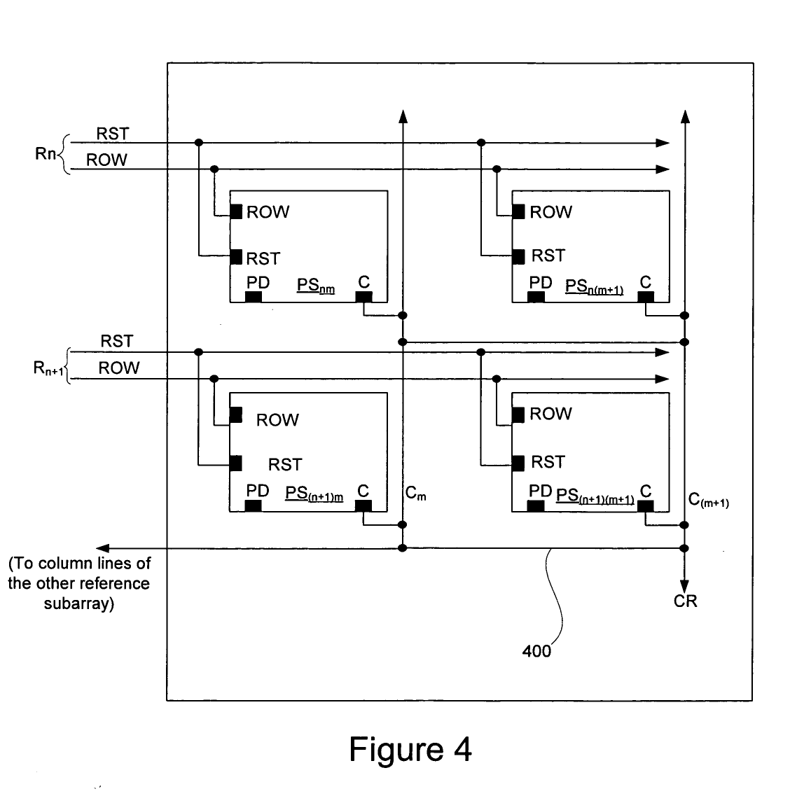

FIG. 4 is a schematic diagram illustrating in more detail the interconnection of the photo sensors or pixels PS within the reference subarrays 102 or 202 of FIGS. 1 and 2 according to an embodiment of the present invention in which each reference subarray includes two or more columns of pixels. Four pixels PS are shown, the top two pixels being coupled to a first row line Rn and the bottom two pixels to a second row line Rn+1. The two left pixels PSₙₘ and PS₍ₙ₊₁₎ₘ are contained in a first column m and coupled to a column line Cₘ while the two right pixels PSₙ₍ₘ₊₁₎ and PS₍ₙ₊₁₎₍ₘ₊₁₎ are contained in a second column m and coupled to a column line Cₘ₊₁. The two column lines Cₘ and Cₘ₊₁ are interconnected through conductive lines 400 as shown, and are also interconnected to the column lines of the other reference subarray (not shown).

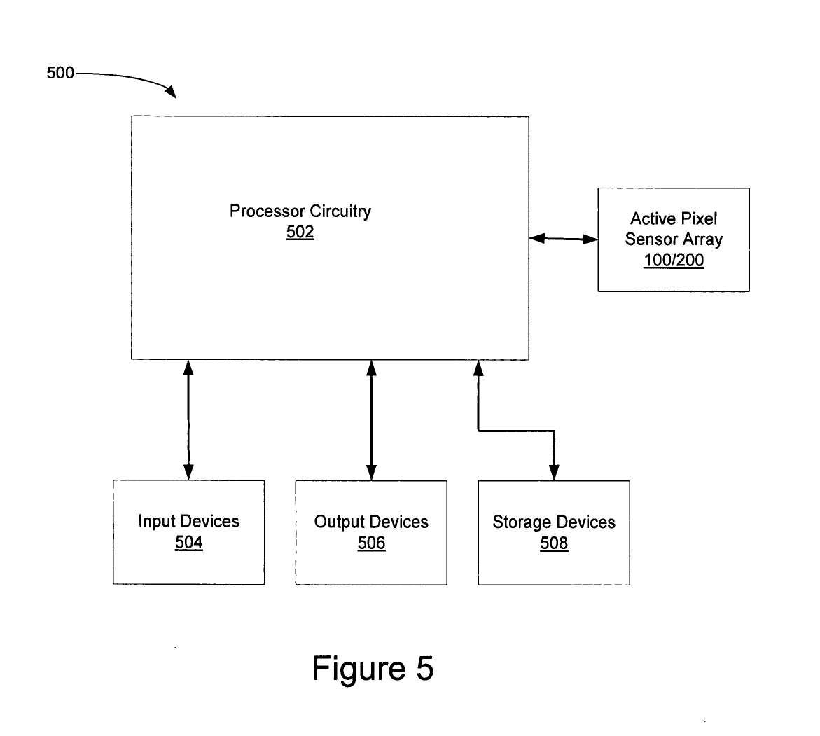

FIG. 5 is a block diagram of an electronic system 500 including processor circuitry 502 coupled to the active pixel sensor array 200 of FIG. 2. The processor circuitry 502 typically includes circuitry for performing various computing and signal processing functions, such as executing specific software to perform specific calculations or tasks and processing signals received from the active pixel sensor array 200. In addition, the electronic system 500 includes one or more input devices 504 which is coupled to the processor circuitry 502 to allow an operator to interface with the electronic system. The input devices may include a keyboard, mouse, numeric key pad, and other suitable input devices. Typically, the electronic system 500 also includes one or more output devices 506 coupled to the processor circuitry 502, such output devices including a liquid crystal display (LCD) or other type of visual display, a printer, and other suitable devices. One or more data storage devices 508 are also typically coupled to the processor circuitry 502 to store data or retrieve data from external storage media (not shown). Examples of typical storage devices 508 include FLASH memory cards, hard and floppy disks, tape cassettes, compact disks (CDs) and digital video disks (DVDs). The system 500 may be, for example, a cellular telephone, a digital still camera, or a digital video camera.

Even though various embodiments of the present invention have been set forth in the foregoing description, the above disclosure is illustrative only, and changes may be made in detail and yet remain within the broad principles of the present invention. Moreover, the functions performed by components in any of the figures can be combined to be performed by fewer elements, separated and performed by more elements, or combined into different functional blocks depending upon a variety factors associated with a particular system being designed, as will be appreciated by those skilled in the art. Furthermore, some of the components described above may be implemented using either digital or analog circuitry, or a combination of both, and also, where appropriate, may be realized through software executing on suitable processing circuitry. Therefore, the present invention is to be limited only by the appended claims.

What is claimed is:

1. An active pixel sensor array, comprising:
an imaging sensor subarray;
a first reference subarray positioned on a first side of the imaging sensor subarray, the first reference subarray including a first reference column line; and
a second reference subarray positioned on a second side of the imaging subarray, the second reference subarray including a second reference column line that is electrically coupled to the first reference column line to generate a common reference signal from the first and second reference subarrays.

2. The active pixel sensor array of claim 1 wherein each of the first and second reference subarrays includes a plurality of rows of pixels and a plurality of columns of pixels, each column of pixels including an associated column line with the column lines of first and second reference subarrays being electrically interconnected.

3. The active pixel sensor array of claim 1 wherein each subarray includes a plurality of pixels arranged in rows and columns.

4. The active pixel sensor array of claim 3 wherein the pixels contained in respective rows of the subarrays are coupled to corresponding row lines, each row line being adapted to receive row controls signals that include a reset signal and a row activation signal.

5. The active pixel sensor array of claim 3 wherein each pixel comprises a 3T pixel including a reset transistor, an access transistor, and a source follower transistor.

6. The active pixel sensor array of claim 1 wherein each of the reference subarrays further includes a plurality of pixels that are covered by at least one metal layer and at least one color filter.

7. An electronic system, comprising:
processor circuitry;
at least one input device coupled to the processor circuitry;
at least one storage device coupled to the processor circuitry;
at least one output device coupled to the processor circuitry; and
at least one active pixel sensor array coupled to the processor circuitry, the active pixel sensor array including
an imaging sensor subarray;
a first reference subarray positioned on a first side of the imaging sensor subarray, the first reference subarray including first reference column lines; and
a second reference subarray positioned on a second side of the imaging subarray, the second reference subarray including second reference column lines that are electrically coupled to the first reference column lines to generate a common reference signal from the first and second reference subarrays.

8. The electronic system of claim 7 wherein the processor circuitry comprises circuitry operable to cause the system to function as at least one of a digital still camera, cellular telephone, and a digital video camera.

9. The electronic system of claim 7 wherein at least one of the input devices comprises a numeric keypad.

10. The electronic system of claim 7 wherein at least one of the output devices comprises a visual display.

11. The electronic system of claim 7 wherein each of the first and second reference subarrays includes a plurality of column lines, with the column lines of first and second reference subarrays being electrically interconnected to electrically couple the second reference subarray to the first reference subarray.

12. The electronic system of claim 11 wherein each reference subarray further includes a plurality of pixels arranged in rows and columns.

13. The electronic system of claim 12 wherein each pixel comprises a 3T pixel including a reset transistor, an access transistor, and a source follower transistor.

14. The electronic system of claim 7 wherein each of the reference subarrays further includes a plurality of pixels that are covered by at least one metal layer and at least one color filter.

15. A method of reading data out of an active pixel sensor array including a plurality of pixels, the method comprising:
generating a first reference signal from a first group of pixels in the array;
generating a second reference signal from a second group of pixels in the array;
combining the first and second reference signals to generate a final reference signal;
generating an imaging signal for each pixel in a third group of pixels in the array; and
generating a pixel output signal for each pixel in the third group of pixels from the from the corresponding imaging signal and the final reference signal.

16. The method of claim 15 wherein combining first and second reference signals comprises coupling column lines of the first and second groups of pixels together.

17. The method of claim 15 wherein the first and second groups of pixels are located on opposing sides of the third group of pixels.

18. The method of claim 15 wherein generating the pixel output signal for each pixel in the third group comprises a differential signal generated from the difference between the corresponding imaging signal and the final reference signal.

19. The method of claim 15 wherein generating the imaging signal for each pixel in the third group of pixels comprises taking a difference between a reset signal level and an exposed signal level for the corresponding pixel.

20. The method of claim 19 wherein generating the final reference signal includes taking the difference between a reset signal level of the combined first and second reference signals and an exposed signal level of the combined first and second reference signals.
